(19) United States
(12) Patent Application Publication
(10) Pub. No.: US 2009/0250533 A1
(43) Pub. Date: Oct. 8, 2009

(54) WASHER NOZZLE-EQUIPPED CAMERA APPARATUS AND WASHER NOZZLE

(75) Inventors: Keiko AKIYAMA, Nukata-gun (JP); Toshiki ISOGAI, Nagoya-city (JP); Kiyonari KOJIMA, Nishikamo-gun (JP); Toshihiro HATTORI, Okazaki-city (JP); Kazuyoshi AKIBA, Nagoya-city (JP)

Correspondence Address: NIXON & VANDERHYE, PC, 901 NORTH GLEBE ROAD, 11TH FLOOR, ARLINGTON, VA, 22203, US

(73) Assignees: DENSO CORPORATION, Kariya-city (JP); NIPPON SOKEN, INC., Nishio-city (JP)

(21) Appl. No.: 12/417,105

(22) Filed: Apr. 2, 2009

(30) Foreign Application Priority Data
Apr. 3, 2008 (JP) 2008-96834

(51) Int. Cl. B05B 1/10

(52) U.S. Cl. 239/284.1

(57) ABSTRACT

A washer nozzle-equipped camera apparatus includes a camera and a washer nozzle. The washer nozzle has a window spray outlet for spraying a washer fluid, supplied from a supply unit such as a pump, on a window of a vehicle. The washer nozzle further has a window duct for carrying the washer fluid to the window spray outlet. The washer nozzle further has a camera spray outlet for spraying the washer fluid on a lens of the camera. The washer nozzle further has a camera duct for carrying the washer fluid to the camera spray outlet.

### CROSS REFERENCE TO RELATED APPLICATION

This application is based on and incorporates herein by reference Japanese Patent Application No. 2008-96834 filed on Apr. 3, 2008.

### FIELD OF THE INVENTION

The present invention relates to a washer nozzle-equipped camera apparatus including a camera and a washer nozzle for spaying washer fluid on a vehicle window and also relates to a washer nozzle having a mounting portion for holding a camera.

### BACKGROUND OF THE INVENTION

JP-A-2004-182080 discloses an infrared camera system including an infrared camera having an infrared transmission portion for capturing infrared rays, a removing portion for removing foreign matters adhering to the infrared transmission portion, a tank for storing a washer fluid used to wash a window of a vehicle, and a pump for pumping the washer fluid from the tank. The removing portion has a first end communicating with the pump and a second end provided with a washer nozzle for spraying the washer fluid supplied from the pump on the infrared transmission portion.

In the infrared camera system disclosed in JP-A-2004-182080, the infrared camera and the washer nozzle are formed as separate pieces and mounted to different positions apart from each other. Therefore, the infrared camera system needs two separate long ducts, one of which is a washer nozzle duct for carrying the washer fluid from the pump to the washer nozzle, and the other of which is an infrared camera duct for carrying the washer fluid from the pump to the infrared camera. As a result, the infrared camera system has a large and complicated structure.

### SUMMARY OF THE INVENTION

In view of the above, it is an object of the present invention to provide a washer nozzle-equipped camera apparatus having a simple structure. It is another object of the present invention to provide a washer nozzle having a mounting portion for holding a camera.

According to an aspect of the present invention, a washer nozzle-equipped camera apparatus includes a camera and a washer nozzle. The washer nozzle has a window spray outlet for spraying a washer fluid, supplied from a supply unit such as a pump, on a window of a vehicle. The washer nozzle further has a window duct for carrying the washer fluid to the window spray outlet. The washer nozzle further has a camera spray outlet for spraying the washer fluid on a lens of the camera. The washer nozzle further has a camera duct for carrying the washer fluid to the camera spray outlet.

According to another aspect of the present invention, a washer nozzle has a window spray outlet for spraying a washer fluid, supplied from a supply unit, on a vehicle window, a camera spray outlet for spraying the washer fluid on a lens of a camera, a mounting portion for holding the camera, a window duct for carrying the washer fluid to the window spray outlet, and a camera duct for carrying the washer fluid to the camera spray outlet.

### BRIEF DESCRIPTION OF THE DRAWINGS

The above and other objectives, features and advantages of the present invention will become more apparent from the following detailed description made with check to the accompanying drawings. In the drawings:

FIG. 1 is a diagram illustrating a side view of a vehicle having a washer nozzle-equipped camera apparatus according to a first embodiment of the present invention;

FIG. 2 is a diagram illustrating a cross-sectional view of the washer nozzle-equipped camera apparatus in which a valve of a switcher does not work;

FIG. 3 is a diagram illustrating an enlarged view of an encircled portion III of FIG. 2;

FIG. 4 is a diagram viewed from a direction indicated by an arrow IV of FIG. 3;

FIG. 5 is a diagram illustrating a cross-sectional view of the washer nozzle-equipped camera apparatus in which the valve of the switcher works; and

FIG. 6 is a diagram illustrating a cross-sectional view of a washer nozzle-equipped camera apparatus according to a second embodiment of the present invention.

### DETAILED DESCRIPTION OF THE PREFERRED EMBODIMENTS

### First Embodiment

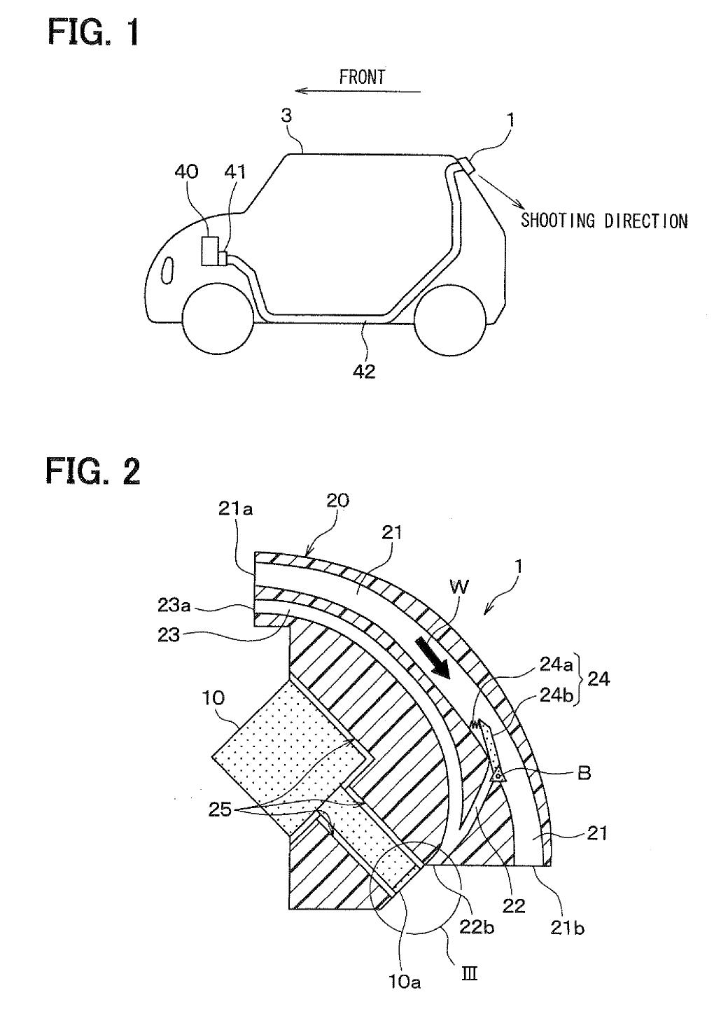

A washer nozzle-equipped camera apparatus 1 according to a first embodiment of the present invention is described below with reference to FIGS. 1-5. As shown in FIG. 1, the washer nozzle-equipped camera apparatus 1 is mounted to an upper portion of a rear window of a vehicle 3.

A washer tank 40 and a pump 41 are installed in an engine room of the vehicle 3. The washer tank 40 stores a washer fluid, and the pump 41 serves as a supply unit for supplying the washer fluid stored in the washer tank 40. A duct 42 is provided between the pump 41 and the washer nozzle-equipped camera apparatus 1 to carry the washer fluid from the pump 41 to the washer nozzle-equipped camera apparatus 1.

Although not shown in the drawings, a windshield washer nozzle is mounted in front of a windshield (i.e., front window) of the vehicle 3 Another duct is provided between the pump 41 and the windshield washer nozzle to carry the washer fluid from the pump 41 to the windshield washer nozzle.

When a driver of the vehicle 3 performs a first operation to wash the rear window, the pump 41 pumps the wash fluid from the washer tank 40 and supplies the wash fluid to the duct 42. In contrast, when the driver performs a second operation to wash the windshield, the pump 41 supplies the wash fluid to the other duct coupled to the windshield washer nozzle.

When the pump 41 starts working in response to the first operation performed by the driver, the washer fluid stored in the washer tank 40 is supplied to the duct 42 and then sprayed from the washer nozzle-equipped camera apparatus 1 on the rear window of the vehicle 3. In contrast, when the pump 41 starts working in response to the second operation performed by the driver, the washer fluid stored in the washer tank 40 is supplied to the other duct and then sprayed from the windshield washer nozzle on the windshield of the vehicle 3.

The pump 41 has two pressure settings (low pressure setting and high pressure setting) for supplying the washer fluid into the duct 42. The driver can switch the pump 41 between the low and high pressure settings.

FIG. 2 illustrates a cross-sectional view of the washer nozzle-equipped camera apparatus 1. The washer nozzle-equipped camera apparatus 1 includes a camera 10 and a washer nozzle 20. The camera 10 has a lens 10a. The washer nozzle 20 is made of resin. The camera 10 and the washer nozzle 20 are integrated together to form the washer nozzle-equipped camera apparatus 1. Thus, the washer nozzle-equipped camera apparatus 1 is provided as a single unit.

For example, the camera 10 shoots an image of the area around the vehicle 3 and projects the image onto a display monitor mounted on the vehicle 3.

The washer nozzle 20 has a washer fluid inlet 21a for receiving the washer fluid supplied from the pump 41 and an air inlet 23a for taking in air.

The washer nozzle 20 further has a window duct 21, a camera duct 22, an air duct 23, and a mounting hole 25. The window duct 21 allows the washer fluid received by the washer fluid inlet 21a to be sprayed on the rear window of the vehicle. The camera duct 22 allows the washer fluid received by the washer fluid inlet 21a to be sprayed on the lens 10a of the camera 10. The air duct 23 allows the air taken in through the air inlet 23a to be sprayed on the lens 10a of the camera 10. The mounting hole 25 allows the camera 10 to be mounted to the washer nozzle 20. Specifically, the camera 10 is inserted in the mounting hole 25 so that the camera 10 and the washer nozzle 20 can be integrated together to form the washer nozzle-equipped camera apparatus 1 as a single unit.

The window duct 21 extends from the washer fluid inlet 21 a to a window spray outlet 21b for spraying the washer fluid on the rear window so as to carry the washer fluid from the washer fluid inlet 21a to the window spray outlet 21b. The washer fluid flows through the window duct 21 in a direction indicated by an arrow W in FIG. 2. The window duct 21 branches at a branch portion B located on the way from the washer fluid inlet 21a to the window spray outlet 21b.

The camera duct 22 extends from the branch portion B of the window duct 21 to a camera spray outlet 22b for spraying the washer fluid on the lens 10a of the camera 10 so as to carry the washer fluid from the branch portion B to the camera spray outlet 22b. Thus, the window duct 21 and the camera duct 22 merge and communicate with the each other.

The camera spray outlet 22b is positioned in a direction substantially parallel to an outer surface of the lens 10a of the camera 10 in such a manner that the camera spray outlet 22b can be located outside the viewing area of the camera 10. The washer fluid flowing through the camera duct 22 is sprayed from the camera spray outlet 22b on the lens 10a.

The camera duct 22 is smaller in cross section than the window duct 21.

A switcher 24 is located at the branch portion B of the window duct 21. The switcher 24 allows and prevents a flow of the washer fluid from the window duct 21 to the camera duct 22.

The switcher 24 includes a spring 24a and a valve 24b coupled to the spring 24a. The valve 24b works against a biasing force of the spring 24a by receiving pressure from the washer fluid flowing through the window duct 21.

The air duct 23 extends from the air inlet 23a to the camera duct 22. Thus, the air duct 23 and the camera duct 22 merge and communicate with the each other.

Although not shown in the drawings, the air inlet 23a is coupled to an air intake port facing the front of the vehicle 3 so that air taken in through the air intake during movement of the vehicle 3 can enter the air duct 23 via the air inlet 23a.

When the vehicle 3 starts moving, the air entering the air duct 23 is blown out from the camera spray outlet 22b by way of a portion of the camera duct 22. In this way, moisture such as rainwater and washer fluid adhering to the lens 10a of the camera 10 is removed by the air blown out from the camera spray outlet 22b so that the lens 10a can be dried.

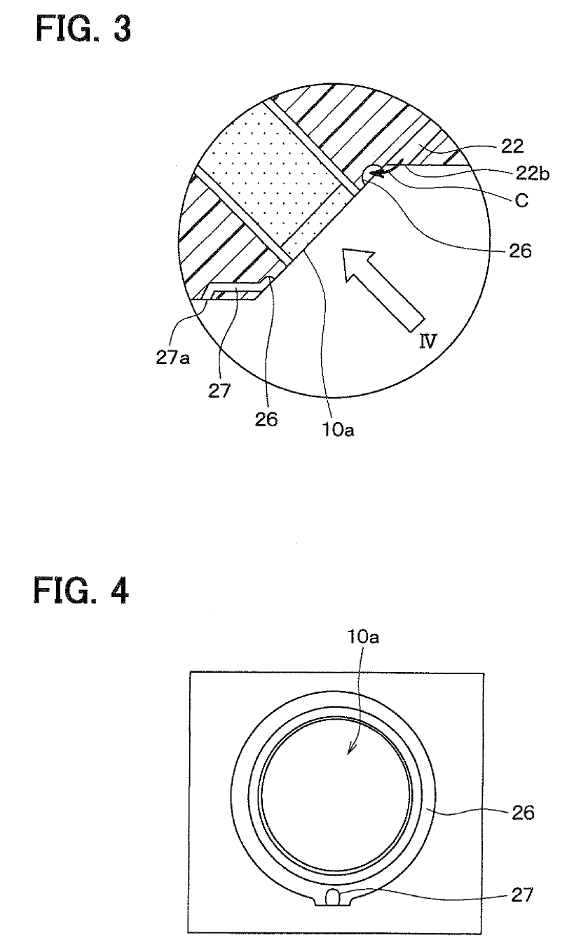

FIG. 3 is a diagram illustrating an enlarged view of an encircled portion III of FIG. 2, and FIG. 4 is a diagram viewed from a direction indicated by an arrow IV of FIG. 3. As shown in FIG. 4, the washer nozzle 20 has a recess 26 such as a groove to surround the periphery of the lens 10a of the camera 10. As shown in FIG. 3, the recess 26 has a semi-circular shape in cross section.

After the lens 10a of the camera 10 is washed, the washer fluid remaining in the camera duct 22 and dripping from the camera spray outlet 22b enters the recess 26 as indicted by an arrow C of FIG. 3. The washer fluid in the recess 26 gathers in the lowest portion of the recess 26. In such an approach, the recess 26 helps prevents the remaining washer fluid from adhering to the lens 10a of the camera 10.

The washer nozzle 20 has a drain duct 27 located at the lowest portion of the recess 26. The drain duct 27 extends from the lowest portion of the recess 26 to a drain outlet 27a exposed to a bottom of the washer nozzle 20 to carry the washer fluid from the lowest portion of the recess 26 to the drain outlet 27a. The washer fluid in the lowest portion of the recess 26 flows through the drain duct 27 and is then drained through the drain outlet 27a.

The washer nozzle-equipped camera apparatus 1 works as follows. As described previously, the pump 41 has the low and high pressure settings for supplying the washer fluid to the duct 42, and the driver can switch the pump 41 between the low and high pressure settings.

When the driver switches the pump 41 to the low pressure setting, pressure of the washer fluid applied to the valve 24b of the switcher 24 becomes less than the biasing force of the spring 24a of the switcher 24 so that the valve 24b cannot work against the biasing force of the spring 24a. Consequently, as shown in FIG. 2, the washer fluid flows from the washer fluid inlet 21a to the window spray outlet 21b.

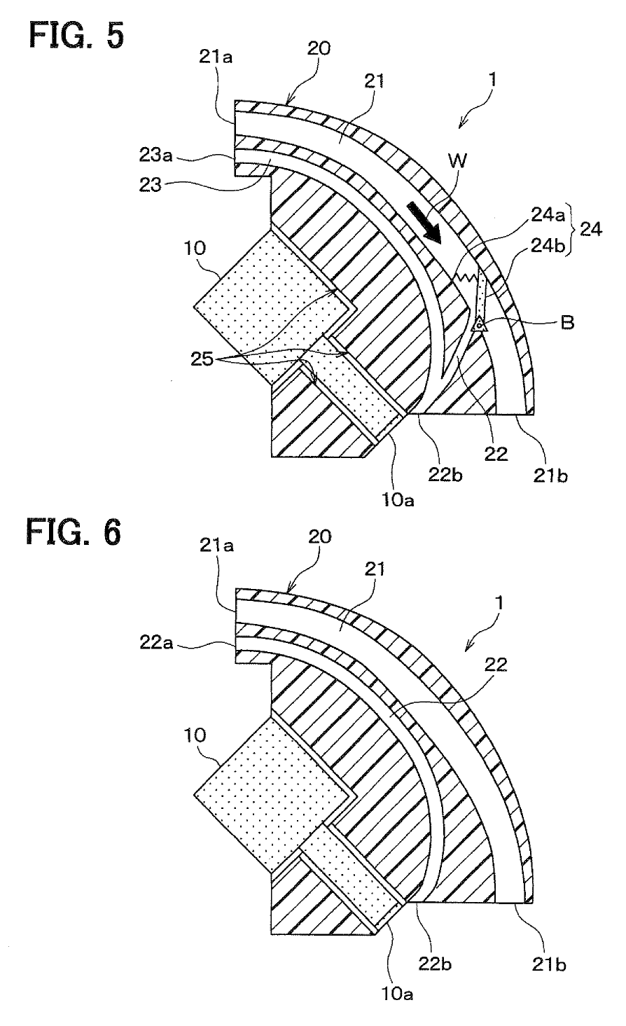

In contrast, when the driver switches the pump 41 to the high pressure setting, the pressure of the washer fluid applied to the valve 24b becomes greater than the biasing force of the spring 24a so that the valve 24b can work against the biasing force of the spring 24a. Consequently, as shown in FIG. 5, the valve 24b opens the camera duct 22 so that the washer fluid can flow from the washer fluid inlet 21a to the camera spray outlet 22b.

In this way, the driver can selectively cause the washer fluid to be sprayed from the window spray outlet 21b and from the camera spray outlet 22b by changing pressure of the washer fluid supplied from the pump 41.

As described above, the washer nozzle-equipped camera apparatus 1 according to the first embodiment has the following features.

The washer nozzle 20 has the window duct 21 for carrying the washer fluid supplied from the pump 41 to the window spray outlet 21b, from which the washer fluid is sprayed on the rear window of the vehicle 3. Further, the washer nozzle 20 has the camera duct 22 for carrying the washer fluid supplied from the pump 41 to the camera spray outlet 22b, from which the washer fluid is sprayed on the lens 10a of the camera 10. Therefore, the washer fluid can be sprayed from the window spray outlet 21b and from the camera spray outlet 22b simply by providing the duct 42 between the pump 41 and the washer nozzle 20.

The camera 10 and the washer nozzle 20 are integrated together to form the washer nozzle-equipped camera apparatus 1 by inserting the camera 10 in the mounting hole 25 of the washer nozzle 20, and then the washer nozzle-equipped camera apparatus 1 is mounted to the vehicle 3. In such an approach, the camera 10 can be easily and preciously mounted to the vehicle 3.

The window duct 21 branches at the branch portion B located on the way from the washer fluid inlet 21a to the window spray outlet 21b. The branch portion B is provided with the switcher 24 configured to allow the washer fluid to flow from the window duct 21 to the camera duct 22. In such an approach, the washer fluid can flow from the washer fluid inlet 21a to the camera spray outlet 22b.

The valve 24b of the switcher 24 works against the biasing force of the spring 24a by receiving pressure of the washer fluid flowing through the window duct 21, when the pressure of the washer fluid is greater than a predetermined value. When the valve 24b works, the valve 24b opens the camera duct 22. Thus, the flow of the washer fluid can be switched to the camera duct 22 by changing the pressure of the washer fluid supplied by the pump 41.

The camera duct 22 is smaller in cross section than the window duct 21. In such an approach, the washer fluid is sprayed from the window spray outlet 21b widely on the rear window of the vehicle 3 and sprayed from the camera spray outlet 22b narrowly (i.e., accurately) on the lens 10a of the camera 10. Further, since the camera duct 22 is smaller than in cross section than the window duct 21, the washer fluid can be sprayed from the camera spray outlet 22b on the lens 10a at high pressure. Therefore, even tough strains such as mud and snow-melting agent on the lens 10a can be surely removed by the washer fluid sprayed from the camera spray outlet 22b.

The washer nozzle 20 has the air inlet 23a for taking in air and the air duct 23 extending from the air inlet 23a to the camera spray outlet 22b to carry the air from the air inlet 23a to the camera spray outlet 22b. In such an approach, moisture such as rainwater and washer fluid on the lens 10a of the camera 10 is removed by the air blown out from the camera spray outlet 22b so that the lens 10a can be dried.

The washer nozzle 20 has the recess 26 such as a groove to surround the periphery of the lens 10a of the camera 10. The washer fluid remaining in the camera duct 22 and dripping from the camera spray outlet 22b enters the recess 26. The washer fluid in the recess 26 gathers in the lowest portion of the recess 26. Thus, the recess 26 helps prevents the remaining washer fluid from adhering to the lens 10a.

The washer nozzle 20 has the drain duct 27 located at the lowest portion of the recess 26. The washer fluid gathering in the lowest portion of the recess 26 flows through the drain duct 27 and is then drained through the drain outlet 27a. Thus, the washer fluid can be drained out of the washer nozzle 20 without affecting the lens 10a of the camera 10.

### Second Embodiment

A waster nozzle-equipped camera apparatus 1 according to a second embodiment of the present invention is described below with reference to FIG. 6. A difference between the first and second embodiments is as follows.

In the first embodiment, the camera duct 22 extends from the branch portion B, which is located on the way from the washer fluid inlet 21a to the window spray outlet 21b of the window duct 21, to the camera spray outlet 22b. Thus, the window duct 21 and the camera duct 22 merge and communicate with each other.

In the second embodiment, as shown in FIG. 6, a camera duct 22 extends substantially parallel to a window duct 21 so that the window duct 21 and the camera duct 22 cannot merge and communicate with each other. Like the first embodiment, a washer nozzle 20 has the recess 26 and the drain duct 27. Unlike the first embodiment, the washer nozzle 20 does not have the air duct 23 and the switcher 24.

The washer nozzle 20 has a first washer fluid inlet 21 a for receiving a washer fluid supplied from the pump 41 and a window spray outlet 21b for spraying the washer fluid on the rear window of the vehicle 3. The window duct 21 extends from the first washer fluid inlet 21a to the window spray outlet 21b to carry the washer fluid from the first washer fluid inlet 21a to the window spray outlet 21b.

The washer nozzle 20 further has a second washer fluid inlet 22a for receiving the washer fluid supplied from the pump 41 and a camera spray outlet 22b for spraying the washer fluid on the lens 10a of the camera 10. The camera duct 22 extends from the second washer fluid inlet 22a to the camera spray outlet 22b to carry the washer fluid from the second washer fluid inlet 22a to the camera spray outlet 22b. The camera duct 22 is smaller in cross section than the window duct 21.

Like the first embodiment shown in FIG. 1, a duct 42 is provided between the pump 41 and the waster nozzle-equipped camera apparatus 1 of the second embodiment. The duct 42 is coupled to the pump 41 at a first end and coupled to the waster nozzle-equipped camera apparatus 1 at a second end. The second end of the duct 42 branches into two parts. One part of the second end of the duct 42 is coupled to the first washer fluid inlet 21a, and the other part of the second end of the duct 42 is coupled to the second washer fluid inlet 22a. Thus, the washer fluid flowing through the duct 42 enter each of the first and second washer fluid inlets 21a, 22a.

When the pump 41 starts working in response to an operation performed by the driver, the washer fluid held in the washer tank 40 is supplied to the duct 42 and then enters each of the first and second washer fluid inlets 21a, 22a. Therefore, the washer fluid is sprayed from the window spray outlet 21b on the rear window of the vehicle 3 substantially at the same time as the washer fluid is sprayed from the camera spray outlet 22b on the lens 10a of the camera 10.

As described above according to the second embodiment of the present invention, the camera duct 22 extends substantially parallel to the window duct 21 so that the window duct 21 and the camera duct 22 cannot merge and communicate with each other. In such an approach, the washer fluid can be sprayed both on the rear window of the vehicle 3 and on the lens 10a of the camera 10 at a time. Alternatively, the second end of the duct 41 can be provided with a switching valve for allowing the washer fluid flowing through the duct 41 to enter one of the first and second washer fluid inlets 21a, 22a. In such an approach, the washer fluid can be sprayed either on the rear window of the vehicle 3 or on the lens 10a of the camera 10 at a time.

(Modifications)

The embodiments described above can be modified in various ways. For example, the waster nozzle-equipped camera apparatus 1 can be mounted to a portion other than the upper portion of the rear window of the vehicle 3.

The camera 10 can be an optional piece of the waster nozzle-equipped camera apparatus 1. That is, the washer nozzle 20 having the mounting portion 25 for holding the camera 10 can be provided alone.

In the first embodiment, the switcher 24 is constructed as a spring valve using the spring 24a and the valve 24b. Alternatively, the switcher 24 can be constructed as a motor valve, a solenoid valve, or the like.

In the first embodiment, the air inlet 23a is coupled to the air intake facing the front of the vehicle 3 so that air taken in through the air intake during movement of the vehicle 3 can enter the air duct 23 via the air inlet 23a. Alternatively, air can be taken in through the air intake using an air blower such as an electric fan.

In the second embodiment, the washer nozzle 20 does not have the air duct 23. Alternatively, like the first embodiment, the washer nozzle 20 of the second embodiment can have the air inlet 23a and the air duct 23 extending from the air inlet 23a to the camera duct 22.

In the embodiments, the washer fluid is sprayed directly on the lens 10a of the camera 10. Alternatively, the lens 10a can be covered with a lens cover, and the washer fluid can be sprayed on the lens cover.

In the embodiments, the recess 26 has a semi-circular shape in cross section. Alternatively, the recess 26 can have a shape other than a semi-circular in cross section.

Such changes and modifications are to be understood as being within the scope of the present invention as defined by the appended claims.

What is claimed is:

1. A washer nozzle-equipped camera apparatus comprising:
a camera having a lens; and
a washer nozzle having a window spray outlet for spraying a washer fluid, supplied from a supply unit, on a vehicle window and a window duct for carrying the washer fluid to the window spray outlet, the washer nozzle further having a camera spray outlet for spraying the washer fluid on the lens of the camera and a camera duct for carrying the washer fluid to the camera spray outlet.

2. The apparatus according to claim 1, wherein
the washer nozzle further has a washer fluid inlet for receiving the washer fluid from the supply unit,
the window duct extends from the washer fluid inlet to the window spray outlet, the window duct branching at a branch portion located on the way from the washer fluid inlet to the window spray outlet, and
the camera duct extends from the branch portion to the camera spray outlet.

3. The apparatus according to claim 2, further comprising:
a switcher located at the branch portion of the window duct to allow the washer fluid to flow from the washer fluid inlet to the camera spray outlet through the camera duct.

4. The apparatus according to claim 3, wherein
the switcher includes a spring and a valve coupled to the spring,
the valve works against a biasing force of the spring by receiving pressure of the washer fluid so that the washer fluid flows from the washer fluid inlet to the camera spray outlet through the camera duct.

5. The apparatus according to claim 1, wherein
the washer nozzle further has first and second washer fluid inlets for receiving the washer fluid from the supply unit,
the window duct extends from the first washer fluid inlet to the window spray outlet, and
the camera duct extends from the second washer fluid inlet to the camera spray outlet.

6. The apparatus according to claim 1, wherein
the camera duct is smaller in cross section than the window duct.

7. The apparatus according to claim 1, wherein
the washer nozzle further has an air inlet for taking in air and an air duct extending from the air inlet to the camera duct.

8. The apparatus according to claim 1, wherein
the washer nozzle further has a recess for preventing the washer fluid from adhering to the lens of the camera, the recess being located to surround the periphery of the lens.

9. The apparatus according to claim 8, wherein
the washer nozzle further has a drain duct for draining the washer fluid in the lowest portion of the recess.

10. A washer nozzle comprising:
a window spray outlet for spraying a washer fluid, supplied from a supply unit, on a vehicle window;
a camera spray outlet for spraying the washer fluid on a lens of a camera;
a mounting portion for holding the camera;
a window duct for carrying the washer fluid to the window spray outlet; and
a camera duct for carrying the washer fluid to the camera spray outlet.
